(19) United States
(12) Patent Application Publication
(10) Pub. No.: US 2026/0138236 A1
(43) Pub. Date: May 21, 2026

(54) GRIPPING DEVICE FOR SEGMENT ERECTOR

(71) Applicant: SHANDONG JIAOTONG UNIVERSITY, Jinan City (CN)

(72) Inventors: Jiuhong RUAN, Jinan City (CN); Xingyu GUO, Jinan City (CN); Jiao GAO, Jinan City (CN); Guodong LI, Jinan City (CN); Fuguang YANG, Jinan City (CN); Haiyan WANG, Jinan City (CN)

(21) Appl. No.: 19/327,386

(22) Filed: Sep. 12, 2025

(30) Foreign Application Priority Data
Nov. 18, 2024 (CN) 202411639352.1

(51) Int. Cl. B25B 5/06

(52) U.S. Cl. CPC B25B 5/061

(57) ABSTRACT

A gripping device for a segment erector is provided, including a drive assembly, a cylinder barrel assembly, a piston, a guide assembly and a centering assembly. The centering assembly includes a centering main structure, cameras and a drive component. The centering main structure includes an end cover, an assembly frame, a bottom cover, and a plurality of claw plates and claw arms. The end cover is fixedly connected to a gripping and lifting plate and the bottom cover. Each of the claw plates is connected to the centering main structure via a matching claw arm. The cameras are mounted on the assembly frame and arranged to face the claw plates. In the process of a gripping head approaching a segment, a relative positional relationship between the gripping head and the segment is identified based on images captured by the cameras. The drive component drives the assembly frame.

### CROSS-REFERENCE TO RELATED APPLICATION

This patent application claims the benefit and priority of Chinese Patent Application No. 202411639352.1 filed with the China National Intellectual Property Administration on Nov. 18, 2024, the disclosure of which is incorporated by reference herein in its entirety as part of the present application.

### TECHNICAL FIELD

The present disclosure relates to the technical field of segment erectors, and in particular to a gripping device for a segment erector.

### BACKGROUND

Gripping devices are widely applicable, ranging from small-scale tasks such as bolt installation, workpiece gripping, and workpiece assembly to large-scale tasks like segment erection, and the gripping devices are required to adjust the pose of end effectors. A gripping device with a simple structure, and functions of automatic centering and automatic reset can improve the adjustment accuracy of the end effector. Most existing gripping devices lack automatic centering function, while those with such a centering function often have relatively complex structures.

For example: The invention patent application CN202211354828.8 discloses a gripping device, which includes an eccentric positioning mechanism and a gripping mechanism. The eccentric positioning mechanism includes a supporting assembly and a floating assembly. The gripping mechanism includes a gripping assembly and a triggering assembly. The gripping assembly includes gripping jaws and a gripping drive source, and the triggering assembly includes triggering members and triggering sensors. When the gripping mechanism moves to the position where a workpiece is located, and the workpiece position is offset or the set angle of the workpiece is tilted, one triggering member abuts against the workpiece, and a floating member is in a floating connection with a support member via a connecting member, allowing the connecting member to drive the floating member to float relative to the support member until all other triggering members abut against the workpiece. At this point, triggering sensors of all the triggering members are activated. In this patent application, the gripping assembly is connected to the floating member and floats synchronously following with the floating member, such that the gripping jaws are effectively aligned with a to-be-gripped position of the workpiece. Then, the gripping drive source drives the gripping jaws to perform a gripping motion, thereby achieving stable gripping of the workpiece and effectively preventing the gripping jaws from damaging the workpiece. The gripping device in this patent application is complex in structure and does not have an automatic reset function.

The invention patent application CN201711251808.7 proposes a segment gripping mechanism for a shield machine erector. A gripping plate of the segment gripping mechanism for the shield machine erector grips a segment assembling head on a segment through a gripping cylinder disposed at a center position thereof and a gripping head connected to a cylinder rod of the gripping cylinder. In the gripping mechanism, the cylinder rod of the gripping cylinder is directly connected to the gripping head. The gripping head does not have an automatic centering function, and forces applied to the gripping head are directly transmitted to the cylinder rod of the gripping cylinder. If an accidental collision occurs between the grasping head and the segment during the segment erection process, the grasping cylinder risks damage.

The invention patent application CN202211344075.2 proposes a chip arranging machine with a wider applicability range and a chap arranging method thereof. A gripping mechanism of the chip arranging machine includes a gripping assembly, an adjusting assembly, and a rotating assembly. The rotating assembly is connected to the gripping assembly, and the adjusting assembly is connected to the gripping assembly. The adjusting assembly is configured to adjust the position of the gripping assembly, thereby improving the gripping accuracy of the chip arranging machine. The chip arranging method is as follows: the adjusting assembly adjusts a gripping range of the gripping assembly, a drive mechanism drives the gripping mechanism to grip a lead frame and transfer the lead frame to a stacking mechanism, the rotating assembly rotates the gripping assembly to place the lead frame at the stacking mechanism, thereby improving the gripping accuracy of the chip arranging machine. The gripping mechanism lacks passive degrees of freedom, and thus does not have the function of automatic centering.

The invention patent CN 202310296517.9 proposes a gripping mechanism including a motor, a cylinder barrel, a piston and a guide assembly. The piston reciprocates within the cylinder barrel under the action of the motor and the guide assembly. The piston includes a piston body and a piston rod located in the piston body. Both ends of the cylinder barrel are respectively provided with cylinder covers for limiting a maximum distance and a minimum distance between the piston body and a piece to be gripped. The piston rod includes a drive shaft, a cross-slider coupling, and a gripping head connected in sequence. Power output by the motor is transmitted in sequence through the drive shaft and the cross-slider coupling to the gripping head, such that the gripping head is screwed into or out of a connection hole in the workpiece to be gripped, thereby realizing gripping and releasing of the workpiece to be gripped. However, a cross sliding block within the structure of the gripping mechanism has a relatively complex structure, resulting in high difficulty in machining and assembly.

In addition, the centering process in the above gripping devices has a low degree of automation and mostly relies on manual operations.

### SUMMARY

It is intended for the present disclosure to at least partially solve one of the technical problems in the related art.

To this end, a gripping device for a segment erector is provided in the present disclosure, which features a simple structure, ease of machining and assembly, and a high degree of automation in the centering process.

To achieve the above-mentioned objective, the technical solutions adapted in the present disclosure are as follows.

A gripping device for a segment erector is provided in the present disclosure, including: a drive assembly, a cylinder barrel assembly, a piston, a guide assembly and a centering assembly. The piston reciprocates within the cylinder barrel assembly under an action of the drive assembly and the guide assembly. The centering assembly and the cylinder barrel assembly are respectively mounted on an upper end surface and a lower end surface of a gripping and lifting plate in the segment erector. The centering assembly is arranged to face a segment to be gripped. The piston comprises a piston body and a piston rod located within the piston body; the piston rod comprises a transmission rod, a cross-slider coupling, and a gripping head that are connected in sequence, with the gripping head partially protruding from the centering assembly. Power output by the drive assembly is transferred to the gripping head via the transmission rod and the cross-slider coupling in sequence to enable the gripping head to screw into or out of a connection hole in the segment to be gripped, enabling gripping or releasing of the segment to be gripped.

The centering assembly is configured to assist in a centering operation between the gripping head and the connection hole in the segment to be gripped by a way of machine vision, and the centering assembly includes a centering main structure, cameras, and a drive component. The centering main structure comprises an end cover, an assembly frame and a bottom cover arranged in sequence from top to bottom, as well as a plurality of claw plates and claw arms. The end cover is fixedly connected to both the gripping and lifting plate and the bottom cover. Each of the claw plates is connected to the centering main structure via a matching one of the claw arms. The cameras are mounted on the assembly frame and arranged to face the claw plates. In a process of the gripping head approaching the connection hole of the segment to be gripped, a relative positional relationship between the gripping head and the connection hole of the segment to be gripped is identified based on images acquired by the cameras, thus determining operating parameters of the drive component. The drive component drives the assembly frame based on the operating parameters to cause the assembly frame to rotate relative to the end cover and the bottom cover around an axial direction of the centering main structure. The claw arms drive the corresponding claw plates to move closer to each other, thus forming a space among the claw plates to allow the gripping head to pass through, restrict a traveling direction of the gripping head and keep the gripping head aligned with the connection hole of the segment to be gripped.

In some embodiments, the end cover, the assembly frame and the bottom cover are annular in shape, and the end cover is provided with a plurality of camera positioning grooves, first bosses, and second bosses. The end cover is fixedly connected to a lower end surface of the gripping and lifting plate via bolts. An axial direction of each of the camera positioning grooves extends in a radial direction of the end cover. The first bosses are circumferentially and uniformly distributed on an inner side of the end cover, each of the first bosses is arranged to avoid a corresponding one of the camera positioning grooves, and each of the first bosses is provided with a first through hole; the second bosses are circumferentially and uniformly distributed on a lower surface of the end cover and project toward the assembly frame, and a counterbore is formed in each of the second bosses. The bottom cover is provided with an annular sliding groove and a plurality of third bosses and fourth bosses. The third bosses are circumferentially and uniformly distributed on an inner side of the bottom cover, and each of the third bosses is located directly below a corresponding one of the first bosses. Each of the third bosses is provided with a first threaded hole coaxial with the corresponding first through hole. The fourth bosses are circumferentially and uniformly distributed on an outer side of the bottom cover, each of the fourth bosses is provided with a second threaded hole coaxial with a corresponding one of the counterbores in the end cover. Bolts are configured to pass through the counterbores in the end cover and the second threaded holes in the bottom cover, enabling a fixed connection between the end cover and the bottom cover. A plurality of circumferentially and uniformly distributed sliding slots are provided on a side wall of the assembly frame. One end of each of the claw arms is reciprocally movable in a corresponding one of the sliding slots. The side wall of the assembly frame is also provided with a plurality of circumferentially and uniformly distributed camera mounting brackets and a fifth boss protruding outward and provided with a second through hole. Each of the camera mounting brackets is aligned with a corresponding one of the camera positioning grooves on the end cover. Each of the cameras is mounted on a corresponding one of the camera mounting brackets; and the fifth boss is hinged to an output end of the drive component via the second through hole.

In some embodiments, each of the claw arms includes a first support arm, a rotary head, and a second support arm which are fixedly connected in sequence, as well as a first rotating shaft and a second rotating shaft. One end of the first support arm is provided with a third through hole, the end of the first support arm is inserted into a corresponding one of the sliding slots of the assembly frame, and the first rotating shaft is inserted into the third through hole. An upper end of the first rotating shaft is fixed on the assembly frame, and a lower end of the first rotating shaft is slidably disposed in the sliding groove of the bottom cover. A fourth through hole for allowing the second rotating shaft to pass through is provided in the rotary head, and the fourth through hole is in a clearance fit with the second rotating shaft.

In some embodiments, the drive component includes a cylinder and a cylinder piston rod. An end of the cylinder is hinged to a connecting bracket, the connecting bracket is fixed to the lower end surface of the gripping and lifting plate, and an end of the cylinder piston rod is hingedly connected to the second through hole in the assembly frame.

In some embodiments, an inner surface of each of the claw plates is an arc surface that is matched with an outer peripheral surface of the gripping head.

In some embodiments, the drive assembly includes a motor, a gearbox and a plurality of reduction gears, and the plurality of reduction gears are meshed in sequence. A base of the motor is fixed on the gearbox. An output shaft of the motor is connected to a central bore of one of the reduction gears; the central bore of another reduction gear is connected to an upper end of the piston rod. Power of the motor is transmitted sequentially through the reduction gears for speed reduction and transmitted to the piston rod to drive a rotation of the piston rod; and an upper end of the piston body is fixedly connected to the gearbox.

In some embodiments, the centering assembly is internally provided with three cameras, three claw plates, and three claw arms.

In some embodiments, the cross-slider coupling includes a first body, a cross sliding block, and a second body which are connected in sequence. An upper end of the first body is fixedly connected to a lower end of the transmission rod. A first guide groove recessed toward an inside of the first body is provided at an end of the first body facing the cross sliding block; and a second guide groove recessed toward an inside of the second body is provided at an end of the second body facing the cross sliding block; an axial direction of the second guide groove is perpendicular to an axial direction of the first guide groove; an end of the second body facing away from the cross sliding block is fixedly connected to the gripping head. The cross sliding block is provided with a first guide surface matched with the first guide groove and a second guide surface matched with the second guide groove; and both the first guide surface and the second guide surface are a combination of an arc surface and a vertical plane.

In some embodiments, two first arc surfaces are further provided at an end of the first body facing the cross sliding block, and the two first arc surfaces are symmetrically disposed on both sides of the first guide groove and located at an edge of the first body; and two second arc surfaces are further provided at an end of the second body facing the cross sliding block, and the two second arc surfaces are symmetrically disposed on both sides of the second guide groove and located at an edge of the second body.

In some embodiments, a connector is provided at a center of the upper end of the first body, and the connector is inserted and fixed into a connection hole in the lower end of the transmission rod; a clamping groove for mounting retaining rings is disposed on an outer peripheral surface of the first body; and the retaining rings are configured to limit a position of a crosshead assembly sleeve along an axial direction of the piston, and the crosshead assembly sleeve is sleeved between the piston body and the outer peripheral surface of the first body.

The gripping device for the segment erector provided in the embodiments of the present disclosure has the following features and beneficial effects compared with the prior art:
(1) The gripping device provided in the embodiments of the present disclosure can achieve active centering between the gripping head and the connection hole of the segment to be gripped, significantly improving the automation degree of the centering process.
(2) The gripping device provided in the embodiments of the present disclosure is not only applicable to the case where the axis of the connection hole of the segment to be gripped coincides with the axis of the gripping head, but also applicable to the case where an angle exists between the axis of the connection hole of the segment to be gripped and the axis of the gripping head. In addition, the gripping device remains applicable to the case where the angle between the axis of the connection hole of the segment to be gripped and the axis of the gripping head is relatively large.
(3) The cross-slider coupling in the gripping device provided in the embodiments of the present disclosure can not only transmit pressure but also transmit tensile, achieving a wide range of applications.
(4) The cross-slider coupling in the gripping mechanism provided in the embodiments of the present disclosure has a compact structure and is suitable for narrow working spaces like a hydraulic cylinder.
(5) When the gripping head of the gripping device provided in the embodiments of the present disclosure accidentally collides with the segment to be gripped, the gripping head moves a certain distance relative to a transmission shaft of the cross-slider coupling and forms a certain angle, thus reducing the impact of the accidental collision on the motor.

Additional aspects and advantages of the present disclosure will be partially provided in the following description, some of which will become apparent from the following descriptions, or will be understood through the practice of the present disclosure.

### BRIEF DESCRIPTION OF THE DRAWINGS

FIG. 1 is a schematic view of an overall structure of a gripping device according to an embodiment of the present disclosure;

FIG. 2 is a cross-sectional view along line A-A in FIG. 1;

FIG. 3 is a schematic structural view of a centering assembly in the gripping device according to an embodiment of the present disclosure;

FIG. 4 is an exploded view of the centering assembly in the gripping device according to an embodiment of the present disclosure;

FIG. 5 is a schematic structural view of a claw arm and a claw plate of the gripping device according to an embodiment of the present disclosure;

FIG. 6A is a schematic structural view of a cylinder barrel assembly of the gripping device according to an embodiment of the present disclosure;

FIG. 6B is a cross-sectional view of the cylinder barrel assembly of the gripping device along line A-A according to an embodiment of the present disclosure;

FIG. 7 is a cross-sectional view of a drive assembly and a piston of the gripping device according to an embodiment of the present disclosure;

FIG. 8 is a schematic structural view of a cross-slider coupling of the gripping device according to an embodiment of the present disclosure; and

FIG. 9 is an exploded view of the cross-slider coupling of the gripping device according to an embodiment of the present disclosure.

### REFERENCE NUMERALS IN THE FIGURES

1: Centering assembly; 11: Centering main structure; A 1: End cover; A 11: Camera positioning groove; A12: First through hole; A13: First boss; A14: Cylindrical counterbore; A15: Second boss; A16: First spring washer; A17: first connecting bolt; A2: Assembly frame; A21: Sliding slot; A22: Camera mounting bracket; A23: Second through hole; A24: Fifth boss; A3: Bottom cover; A31: First threaded hole; A32: Third boss; A33: Sliding groove; A34: Fourth boss; A35: Second threaded hole; A36: Second spring washer; A37: Second connecting bolt; A4:
   Claw plate; A5: Claw arm; A51: First support arm; A511: Third through hole; A52: Second support arm; A53: Rotary head; A531: Fourth through hole; A54: First rotating shaft; A55:
   Second rotating shaft; 12: Camera; 13: Drive component; 131: Cylinder; 132: Cylinder piston rod; 133: Connecting bracket;
2: Guide assembly: 21: Guide rod; 22: Washer; 23: Double locking nuts;
3: Cylinder barrel assembly; 31: Gripping and lifting plate connecting sleeve; 32: Cylinder barrel adapter sleeve; 321: First shaft shoulder; 322: Second shaft shoulder; 323: Shaft collar; 33: Cylinder barrel; 331: First cylinder cover; 332: Second cylinder cover; 333: guide sleeve; 334: Channel; 335: Oil inlet; 336: Oil outlet;
4: Piston; 410: Piston body; 411: Third shaft shoulder; 411a: First shaft groove; 411b: Second shaft groove; 411c: First sealing ring; 411d: Second sealing ring; 420: Piston rod; 421: Transmission rod; 422: Cross-slider coupling; B1: First body; B11: Connector; B12: First arc surface; B13: First guide groove; B14: Clamping groove; B2: Cross sliding block; B21: first guide surface; B22: Second guide surface; B3: Second body; B31: Second arc surface; B32: Second guide groove; C 11: Retaining ring; C 12: Spring washer; C 13: Screw; 423: Gripping head; 423a: External thread; 424: Connection hole; 425: Crosshead assembly sleeve;
5: Drive assembly; 51: Motor; 52: Gearbox; 53: First reduction gear; 54: Second reduction gear; 55: Third reduction gear;
6: Gripping and lifting plate;
7: Spherical hinge; 72: Spherical hinge bracket;
8: Flange plate.

### DETAILED DESCRIPTION OF THE EMBODIMENTS

In order to make objectives, technical solutions, and advantages of the present disclosure clearer, the following further describes the present disclosure in detail with reference to drawings and embodiments. It should be understood that the specific examples described herein are merely used to explain the present disclosure and are not intended to limit the present disclosure.

On the contrary, the present disclosure covers any alternatives, modifications, equivalent methods, and solutions that fall within the spirit and scope of the present disclosure as defined by the claims. Furthermore, in order to provide a better public understanding of the present disclosure, some specific details are described in detail in the following description. However, those skilled in the art can fully understand the present disclosure without the description of these detailed parts.

The structures, proportions, sizes, etc., depicted in the drawings of this specification are only intended to match the content disclosed in the specification for those who are familiar with this technology to understand and read, and are not intended to limit the implementable limiting conditions of the present disclosure. Therefore, they have no technical substantive meaning, and any modification of the structure, change of the proportional relationship, or adjustment of the size that do not affect the efficacy or the intended purpose achieved in the present disclosure shall still fall within the scope of the technical content disclosed in the present disclosure. In addition, terms such as “upper,” “lower,” “left,” “right,” “middle,” and “one” as used in this specification are merely for clarity of description and are not intended to limit the implementable scope of the present disclosure. Any change or adjustment of the relative relationships shall also be deemed as the implementable scope of the present disclosure, provided that there is no substantial change in the technical content.

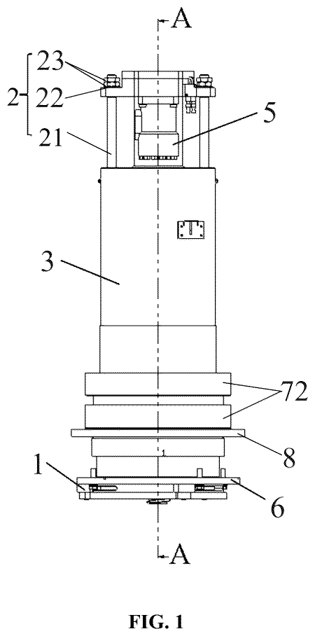

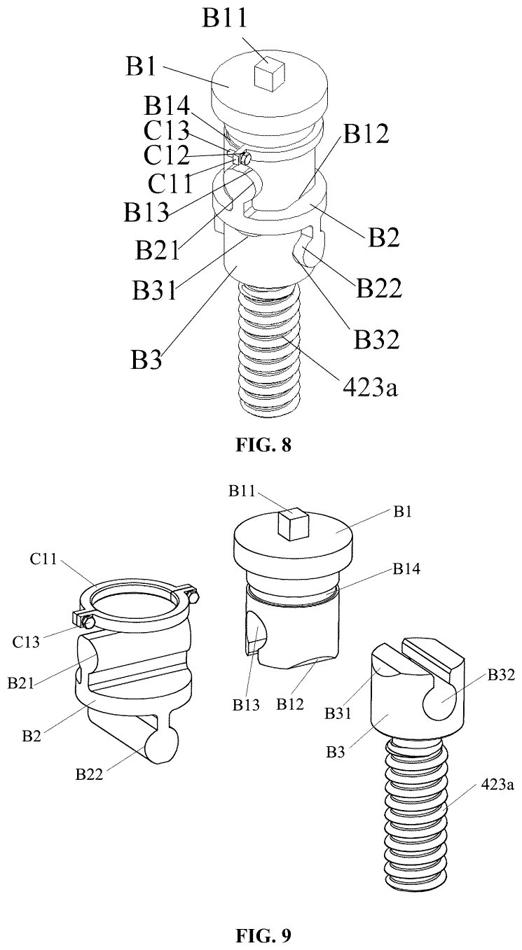

Referring to FIGS. 1 to 9, a gripping device for a segment erector provided in an embodiment of the present disclosure includes: a drive assembly 5, a cylinder barrel assembly 3, a piston 4, a guide assembly 2 and a centering assembly 1. The piston 4 reciprocates within the cylinder barrel assembly 3 under the action of the drive assembly 5 and the guide assembly 2. The centering assembly 1 and the cylinder barrel assembly 3 are respectively mounted on upper and lower end surfaces of a gripping and lifting plate 6 in the segment erector. The centering assembly 1 is arranged to face a segment to be gripped (which is not shown in the figure). The piston 4 includes a piston body 410 and a piston rod 420 located within the piston body 410. The piston rod 420 includes a transmission rod 421, a cross-slider coupling 422 and a gripping head 423 that are connected in sequence, with the gripping head 423 partially protruding from the centering assembly 1. Power output by the drive assembly 5 is transferred to the gripping head 423 via the transmission rod 421 and the cross-slider coupling 422 in sequence to enable the gripping head 423 to screw into or out of a connection hole in the segment to be gripped, enabling gripping or releasing of the segment to be gripped.

The centering assembly 1 is configured to assist in a centering operation between the gripping head 423 and the connection hole in the segment to be gripped by a way of machine vision. The centering assembly 1 includes a centering main structure 11, cameras 12 and a drive component 13. The centering main structure 11 includes an annular end cover A1, an annular assembly frame A2 and an annular bottom cover A3 arranged in sequence from top to bottom, as well as multiple claw plates A4 and claw arms A5. The end cover A1 is fixedly connected to both the gripping and lifting plate 6 and the bottom cover A3. Each of the claw plates A4 is connected to the centering main structure 11 via a matching claw arm A5. The cameras 12 are mounted on the assembly frame A2 and arranged to face the claw plates A4. As the gripping head 423 approaches the connection hole of the segment to be gripped, a relative positional relationship between the gripping head 423 and the connection hole of the segment to be gripped is identified based on images acquired by the cameras 12, thereby determining operating parameters of the drive component 13. Under this working parameter, the drive component 13 drives the assembly frame A2 to rotate relative to the end cover A1 and the bottom cover A3 around an axial direction of the centering main structure 11; and meanwhile, the claw arms A5 drive the corresponding claw plates A4 to move closer to each other. A space is formed among all the claw plates A4 to allow the gripping head 423 to pass through, and restrict a traveling direction of the gripping head 423 thus keeping the gripping head 423 aligned with the connection hole of the segment to be gripped.

In some embodiments, referring to FIGS. 3 to 5, the centering assembly 1 is preferably internally provided with three cameras 12, three claw plates A4 and three claw arms A5. The specific structures of each component in the centering assembly 1 will be described in detail below.

The centering main structure 11 mainly includes the end cover A1, the assembly frame A2, and the bottom cover A3, which are coaxially arranged in a layered manner. The end cover A1, the assembly frame A2 and the bottom cover A3 are all annular with the same inner diameter. The end cover A1 is disposed closer to a bottom end of the cylinder barrel assembly 3 relative to the bottom cover A3. In addition, the end cover A1 is fixedly connected to both the gripping and lifting plate 6 and the bottom cover A3. The assembly frame A2 is rotatable around the axial direction of the centering main structure 11 relative to the end cover A1 and the bottom cover A3 under the driving of the drive component 13. The end cover A1 is provided with three camera positioning grooves A11, three first bosses A13 and three second bosses A15. The end cover A1 is fixedly connected to the lower end surface of the gripping and lifting plate 6 via first connecting bolts A17 and first spring washers A16. An axial direction of each of the camera positioning grooves A11 extends in a radial direction of the end cover A1. The cameras 12 are positioned by means of the camera positioning grooves A11 when the cameras 12 are mounted to the assembly frame A2, enabling the quick and accurate installation thereof. The three first bosses A13 are circumferentially and uniformly distributed on an inner side of the end cover A1 and project toward the center of the end cover A1. Each of the first bosses A13 is arranged to avoid a corresponding one of the camera positioning grooves A11, and each of the first bosses A13 is provided with a first through hole A12. The three second bosses A15 are circumferentially and uniformly distributed on a lower surface of the end cover A1 and project toward the assembly frame A2. A cylindrical counterbore A14 is formed in each of the second bosses A15. The bottom cover A3 is provided with an annular sliding groove A33, three third bosses A32 and three fourth bosses A34. The three third bosses A32 are circumferentially and uniformly distributed on an inner side of the bottom cover A3 and project toward the center of the bottom cover A3. Each of the third bosses A32 is located directly below a corresponding one of the first bosses A13. Each of the third bosses A32 is provided with a first threaded hole A31 coaxial with the corresponding first through hole A12. The three fourth bosses A34 are circumferentially and uniformly distributed on an outer side of the bottom cover A3. Each of the fourth bosses A34 is provided with a second threaded hole A35 coaxial with a corresponding one of the cylindrical counterbores A14 in the end cover A1. Second spring washers A36 are provided at each of the cylindrical counterbores A14 in the end cover A1, respectively. Second connecting bolts A37 pass through the cylindrical counterbores A14 in the second bosses A15 and are screwed into the second threaded holes A35 of the fourth bosses A34 on the bottom cover A3, thereby achieving a fixed connection between the end cover A1 and the bottom cover A3. The assembly frame A2 is mainly used for the mounting of the cameras 12 and the claw arms A5. Three sliding slots A21 are circumferentially and uniformly formed in a side wall of the assembly frame A2. One end of each of the claw arms A5 can reciprocate within a corresponding one of the sliding slots A21. The side wall of the assembly frame A2 is also provided with three circumferentially and uniformly distributed camera mounting brackets A22 and a fifth boss A24 that projects outward and is provided with a second through hole A23. The camera mounting brackets A22 are aligned with the camera positioning grooves A11 on the end cover A1. The cameras 12 are mounted on the corresponding camera mounting brackets A22. The fifth boss A24 is hinged to an output end of the drive component 13 via the second through hole A23.

The arrangement of the three cameras 12 can ensure the acquisition of images from various perspectives during the centering process between the gripping head 423 and the segment to be gripped, which facilitates the subsequent image processing (the specific image processing process adopts existing image processing methods in the art) to identify a relative pose relationship between the gripping head 423 and the segment to be gripped, and further determine operating parameters of the drive component 13 to enable each of the claw plates A4 to reach a target position, thus constraining a traveling direction of the gripping head 423.

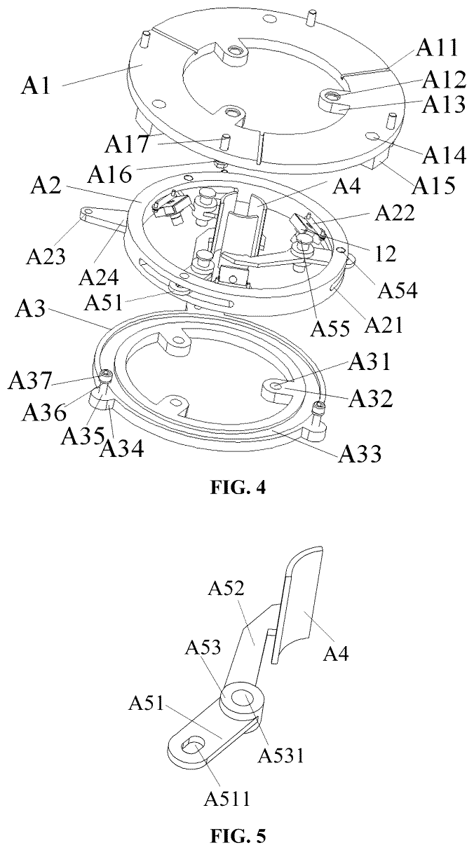

The claw arms A5 act as transmission components in the centering assembly 1 and are used for transmitting the power output from the drive component 13 to the corresponding claw plates A4. In this embodiment, the structures of the three claw arms A5 are identical, and one of the three claw arms will be described as an example. Referring to FIG. 4 and FIG. 5, the claw arm A5 includes a first support arm A51, a rotary head A53, and a second support arm A52 that are fixedly connected in sequence, as well as a first rotating shaft A54 and a second rotating shaft A55. One end of the first support arm A51 is provided with a third through hole A511. The end of the first support arm A51 is inserted into a corresponding one of the sliding slots A21 of the assembly frame A2. Subsequently, the first rotating shaft A54 is inserted into the third through hole A511, and an upper end of the first rotating shaft A54 is fixed on the assembly frame A2. After a lower end of the first rotating shaft A54 passes through the assembly frame A2, the lower end of the first rotating shaft A54 is located in the sliding groove A33 of the bottom cover A3 and is slidable in the sliding groove A33. Thus, one end of the first support arm A51 is rotatable around the first rotating shaft A54, and the sliding slot A21 provides a space for the movement of the first support arm A51. The other end of the first support arm A51 and one end of the second support arm A52 are fixedly connected by means of the rotary head A53. A fourth through hole A531 is formed in the rotary head A53. Specifically, the second rotating shaft A55 sequentially passes through the first through hole A12 in the first boss A13 of the end cover A1 and the fourth through hole A531 in the rotary head A53 in the assembly frame A2, and is fixed in the first threaded hole A31 in the third boss A32 of the bottom cover A3. The fourth through hole A531 is in a clearance fit with the second rotating shaft A55, i.e., the first support arm A51 and the second support arm A52, as a whole, are rotatable relative to the second rotating shaft A55.

The claw plate A4 is integrally formed at an end of the second support arm A52 of the claw arm A5 close to the center of the assembly frame A2. An inner surface of the claw plate A4 is an arc surface matching an outer peripheral surface of the gripping head 423. When The claw plates A4 move closer to each other, a space is formed for enveloping the outer peripheral surface of the gripping head 423.

The drive component 13 adopts a pneumatic driving mode to provide power for the assembly frame A2, the claw arms A5 and the claw plates A4. Specifically, the drive component 13 includes a cylinder 131 and a cylinder piston rod 132. An end of the cylinder 131 is hinged to a connecting bracket 133, and the connecting bracket is fixedly connected to the lower end surface of the gripping and lifting plate 6. An end of the cylinder piston rod 132 is hingedly connected to the second through hole A23 of the fifth boss A24 in the assembly frame A2. The assembly frame A2 rotates about an axial direction of the centering assembly under the action of the cylinder 131 and the cylinder piston rod 132 and simultaneously drives the first rotating shafts A54 of the claw arms A5 to reciprocate within the sliding groove A33 of the bottom cover A3, enabling the claw plates A4 to grip and release the gripping head 423.

It can be understood that the centering assembly 1 in this embodiment enables active centering during the segment gripping process, thus improving the automation degree of the gripping device.

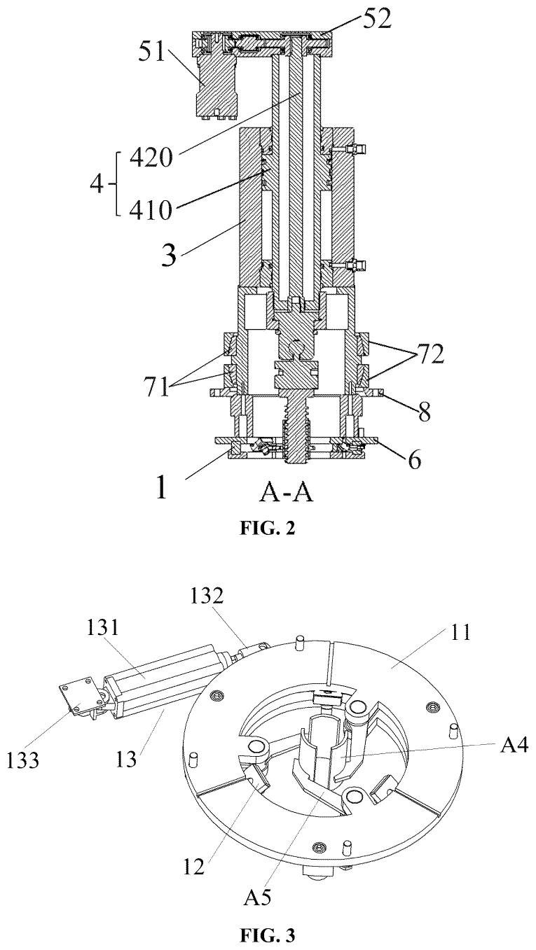

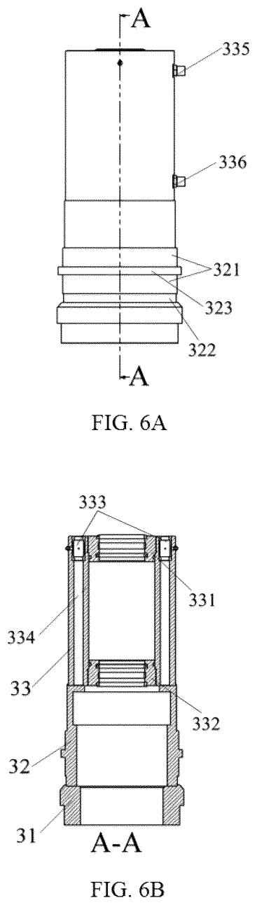

Referring to FIG. 1, FIG. 2, and FIG. 6A and FIG. 6B, the cylinder barrel assembly 3 includes a gripping and lifting plate connecting sleeve 31, a cylinder barrel adapter sleeve 32 and a cylinder barrel 33 which are arranged coaxially. An upper end of the cylinder barrel adapter sleeve 32 is fixedly connected to a lower end of the cylinder barrel 33, and a lower end of the cylinder barrel adapter sleeve 32 is fixedly connected to an upper end of the gripping and lifting plate connecting sleeve 31. Two first shaft shoulders 321, one second shaft shoulder 322 and one shaft collar 323 are disposed on an outer side wall of the cylinder barrel adapter sleeve 32. The two first shaft shoulders 321 are respectively arranged on upper and lower sides of the shaft collar 323, and the second shaft shoulder 322 is located at the lower end of the cylinder barrel adapter sleeve 32. The cylinder barrel adapter sleeve 32 is connected to a lifting clamp of the segment erector (the lifting clamp is not shown in the figure) by means of two spherical hinges 71 spaced apart from each other. Two spherical hinge brackets 72 are fixed inside the lifting clamp of the segment erector. The two spherical hinges 71 are respectively sleeved on the two first shaft shoulders 321. A flange plate 8 fixedly connected to the lifting clamp of the segment erector is fixedly sleeved on the second shaft shoulder 322. The cylinder barrel assembly 3 is rotatable relative to the lifting clamp of the segment erector around three axes passing through centers of the spherical hinges 71. Axial movement along the cylinder barrel assembly 3 between the cylinder barrel assembly 3 and the lifting clamp of the segment erector is prevented by means of the shaft collar 323 and the flange plate 8. A first cylinder cover 331 and a second cylinder cover 332 are arranged at upper and lower ends of the cylinder barrel 33, respectively and used for limiting an axial movement range of the piston 4. A guide sleeve 333 matched with the guide assembly 2 is also fixedly connected to the upper end of the cylinder barrel 33. Both opposite side walls of the cylinder barrel 33 are provided with channels 334 in the axial direction of the cylinder barrel 33. The channels 334 serve as a movement space for the guide assembly 2. The side wall of the cylinder barrel 33 is also provided with an oil inlet 335 and an oil outlet 336 for hydraulic oil to enter and exit the cylinder barrel. The hydraulic oil drives the piston 4 and the drive assembly 5, via the oil inlet 335 and the oil outlet 336, to reciprocate within the cylinder barrel assembly 3 under the guidance of the guide assembly 2.

In some embodiments, referring to FIG. 1, the guide assembly 2 includes two guide rods 21. One end of each of the two guide rods 21 is fixed to the drive assembly 5 via a washer 22 and double locking nuts 23. The other end of each of the two guide rods 21 passes through the guide sleeve 333 inside the cylinder barrel 33 and follow the piston 4 to reciprocate relative to the cylinder barrel 33 within the channel 334 in the side wall of the cylinder barrel 33.

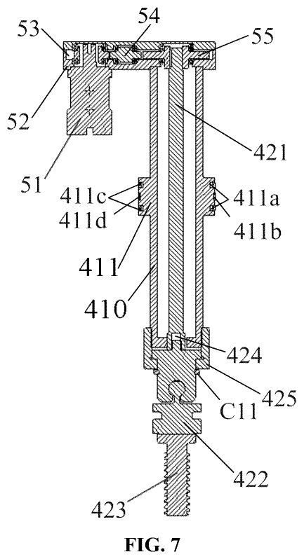

In some embodiments, referring to FIG. 1, FIG. 2 and FIG. 7, the drive assembly 5 includes a motor 51, a gearbox 52, and three reduction gears mounted within the gearbox 52. A base of the motor 51 is fixed on the gearbox 52. An output shaft of the motor 51 is connected to a central bore of the first reduction gear 53. The first reduction gear 53, the second reduction gear 54 and the third reduction gear 55 are meshed in sequence. The central bore of the third reduction gear 55 is connected to an upper end of the piston rod 420. Power of the motor 51 is transmitted sequentially through the first reduction gear 53, the second reduction gear 54 and the third reduction gear 55 for speed reduction and then transmitted to the piston rod 420 to drive the rotation of the piston rod 420; and an upper end of the piston body 410 is fixedly connected to the gearbox 52.

In some embodiments, referring to FIGS. 7 to 9, in the piston 4, the piston body 410 is a hollow cylindrical structure. An outer side wall of the piston body 410 is provided with a third shaft shoulder 411. The third shaft shoulder 411 is provided with two first shaft grooves 411a and a second shaft groove 411b located between the two first shaft grooves 411a. Two first sealing rings 411c are provided in the two first shaft grooves 411a, respectively. A second sealing ring 411d is provided in the second shaft groove 411b and mainly used for preventing leakage of hydraulic oil. During the reciprocating movement of the piston 4 within the cylinder barrel assembly 3, an upper surface of the third shaft shoulder 411 is restricted by the first cylinder cover 331, so that the piston 4 cannot continue to move in a direction away from the segment to be gripped, thus limiting a maximum distance of the piston 4 in the axial direction. A lower surface of the third shaft shoulder 411 is restricted by the second cylinder cover 332, so that the piston 4 cannot continue to move in a direction close to the segment to be gripped, thus limiting a minimum distance of the piston 4 in the axial direction.

In the piston rod 420 of the piston 4, a lower end of the transmission rod 421 is provided with a connection hole 424 protruding from a lower end of the piston body 410. The cross-slider coupling 422 includes a first body B1, a cross sliding block B2 and a second body B3 which are connected in sequence. A connector B11 is fixedly arranged at a center of an upper end of the first body B1. The connector B11 is inserted into the connection hole 424. In addition, a clamping groove B14 is provided on an outer peripheral surface of an upper-middle portion of the first body B1. Two sets of spring washers C12 and screws C13 are used to fix the two retaining rings C11 within the clamping groove B14, restricting a position of the crosshead assembly sleeve 425 along an axial direction of the piston 4, with the crosshead assembly sleeve 425 sleeved between the outer peripheral surfaces of the piston body 410 and the first body B1, thus fixedly connecting the transmission rod 421 to the first body B1 of the cross-slider coupling 422. A first guide groove B13 recessed toward the inside of the first body B1 and two first arc surfaces B12 symmetrically provided on both sides of the first guide groove B13 and located at an edge of the first body B1 are formed by milling at an end of the first body B1 facing the cross sliding block B2. A second guide groove B32 recessed toward the inside of the second body B3 and two second arc surfaces B31 symmetrically provided on both sides of the second guide groove B32 and located at an edge of the second body B3 are formed by milling at an end of the second body B3 facing the cross sliding block B2. An axial direction of the second guide groove B32 is perpendicular to an axial direction of the first guide groove B13. An end of the second body B3 facing away from the cross sliding block B2 is fixedly connected to the gripping head 423. The outer peripheral surface of the gripping head 423 is provided with an external thread 423a matched with an internal thread of the connection hole of the segment to be gripped. The cross sliding block B2 is provided with a first guide surface B21 tangential to the first guide groove B13 and a second guide surface B22 tangential to the second guide groove B32, respectively. Both the first guide surface B21 and the second guide surface B22 are a combination of an arc surface and a vertical plane.

The output shaft of the motor 51 drives the first reduction gear 53, the second reduction gear 54, the third reduction gear 55, and the transmission rod 421 to rotate. The transmission rod 421 transmits the rotation of the motor after three-stage speed reduction to the first body B1 of the cross-slider coupling 422. The first body B1 transmits torque to the second body B3 via the cross sliding block B2 and then to the gripping head 423. Since both the first guide surface B21 and the second guide surface B22 of the cross sliding block B2 are a combination of the arc surface and the plane, the presence of the arc surface prevents the first body B1 and the second body B3 from being separated under tension from the cross sliding block B2. The cross-slider coupling 422 transmits not only pressure, but also tension. The first body B1 and the second body B3 of the cross-slider coupling are movable along the central axes of curved surfaces of the first guide surface B21 and the second guide surface B22 of the cross sliding block B2, respectively, and are rotatable around the central axes of the curved surfaces of the first guide surface B21 and the second guide surface B22 of the cross sliding block B2, respectively. Since the first body B1 and the second body B3 of the cross-slider coupling are respectively provided with the first arc surface B12 and the second arc surface B31, the first body B1 and the second body B3 of the cross-slider coupling 422 can rotate by ±60° around the central axes of the curved surfaces of the first guide surface B21 and the second guide surface B22 of the cross sliding block B2, thus enhancing an application range of the coupling. It is not only suitable for the case where there is an angle between the axis of the connection hole of the segment to be gripped and the axis of the gripping head, but also remains applicable in the case that the angle between the axis of the connection hole of the segment to be gripped and the axis of the gripping head is large.

In the description of this specification, descriptions with reference to the terms such as “one embodiment”, “some embodiments”, “example”, “specific example”, or “some examples” mean that specific features, structures, materials, or characteristics described with reference to the embodiments or example are included in at least one embodiment or example of the present disclosure. In this specification, the illustrative statements of the above terms are not necessarily directed to the same embodiment or example. Moreover, the described specific features, structures, materials or characteristics can be combined in any one or more embodiments or examples in a suitable manner. Additionally, without contradiction, those skilled in the art may combine and integrate different embodiments or examples described in this specification, along with the features of these embodiments or examples.

Although the examples of the present disclosure have been shown and described above, it should be understood that the examples described above are exemplary and should not be construed as limiting the present disclosure. Those skilled in the art may make variations, modifications, substitutions, and variations to the above-mentioned examples within the scope of the present disclosure.

What is claimed is:

1. A gripping device for a segment erector, comprising a drive assembly, a cylinder barrel assembly, a piston, a guide assembly and a centering assembly, wherein the piston reciprocates within the cylinder barrel assembly under an action of the drive assembly and the guide assembly; the centering assembly and the cylinder barrel assembly are respectively mounted on an upper end surface and a lower end surface of a gripping and lifting plate in the segment erector; the centering assembly is arranged to face a segment to be gripped; the piston comprises a piston body and a piston rod located within the piston body; the piston rod comprises a transmission rod, a cross-slider coupling, and a gripping head that are connected in sequence, wherein the gripping head partially protrudes from the centering assembly; power output by the drive assembly is transferred to the gripping head via the transmission rod and the cross-slider coupling in sequence to enable the gripping head to screw into or out of a connection hole in the segment to be gripped, enabling gripping or releasing of the segment to be gripped;
the centering assembly is configured to assist in a centering operation between the gripping head and the connection hole in the segment to be gripped by a way of machine vision; the centering assembly comprises a centering main structure, cameras, and a drive component; the centering main structure comprises an end cover, an assembly frame and a bottom cover arranged in sequence from top to bottom, as well as a plurality of claw plates and claw arms, wherein the end cover is fixedly connected to both the gripping and lifting plate and the bottom cover; each of the claw plates is connected to the centering main structure via a matching one of the claw arms; the cameras are mounted on the assembly frame and arranged to face the claw plates; in a process of the gripping head approaching the connection hole of the segment to be gripped, a relative positional relationship between the gripping head and the connection hole of the segment to be gripped is identified based on images acquired by the cameras, thereby determining operating parameters of the drive component; the drive component drives the assembly frame based on the operating parameters to cause the assembly frame to rotate relative to the end cover and the bottom cover around an axial direction of the centering main structure; and the claw arms drive the corresponding claw plates to move closer to each other, thereby forming a space among the claw plates to allow the gripping head to pass through, restrict a traveling direction of the gripping head and keep the gripping head aligned with the connection hole of the segment to be gripped.

2. The gripping device according to claim 1, wherein the end cover, the assembly frame and the bottom cover are annular in shape, and the end cover is provided with a plurality of camera positioning grooves, first bosses, and second bosses; the end cover is fixedly connected to a lower end surface of the gripping and lifting plate via bolts; an axial direction of each of the camera positioning grooves extends in a radial direction of the end cover; the first bosses are circumferentially and uniformly distributed on an inner side of the end cover, each of the first bosses is arranged to avoid a corresponding one of the camera positioning grooves, and each of the first bosses is provided with a first through hole; the second bosses are circumferentially and uniformly distributed on a lower surface of the end cover and project toward the assembly frame, and a counterbore is formed in each of the second bosses; the bottom cover is provided with an annular sliding groove and a plurality of third bosses and fourth bosses, wherein the third bosses are circumferentially and uniformly distributed on an inner side of the bottom cover, and each of the third bosses is located directly below a corresponding one of the first bosses; each of the third bosses is provided with a first threaded hole coaxial with the first through hole; the fourth bosses are circumferentially and uniformly distributed on an outer side of the bottom cover, each of the fourth bosses is provided with a second threaded hole coaxial with a corresponding one of the counterbores in the end cover; bolts are configured to pass through the counterbores in the end cover and the second threaded holes in the bottom cover, enabling a fixed connection between the end cover and the bottom cover; and a plurality of circumferentially and uniformly distributed sliding slots are provided on a side wall of the assembly frame; one end of each of the claw arms is reciprocally movable in a corresponding one of the sliding slots; the side wall of the assembly frame is also provided with a plurality of circumferentially and uniformly distributed camera mounting brackets and a fifth boss protruding outward and provided with a second through hole; each of the camera mounting brackets is aligned with a corresponding one of the camera positioning grooves on the end cover; each of the cameras is mounted on a corresponding one of the camera mounting brackets; and the fifth boss is hinged to an output end of the drive component via the second through hole.

3. The gripping device according to claim 2, wherein each of the claw arms comprises a first support arm, a rotary head, and a second support arm which are fixedly connected in sequence, as well as a first rotating shaft and a second rotating shaft; one end of the first support arm is provided with a third through hole, an end of the first support arm is inserted into a corresponding one of the sliding slots of the assembly frame, and the first rotating shaft is inserted into the third through hole; an upper end of the first rotating shaft is fixed on the assembly frame, and a lower end of the first rotating shaft is slidably disposed in the sliding groove of the bottom cover; and a fourth through hole for allowing the second rotating shaft to pass through is provided in the rotary head, and the fourth through hole is in a clearance fit with the second rotating shaft.

4. The gripping device according to claim 2, wherein the drive component comprise a cylinder and a cylinder piston rod; an end of the cylinder is hinged to a connecting bracket, the connecting bracket is fixed to the lower end surface of the gripping and lifting plate, and an end of the cylinder piston rod is hingedly connected to a second through hole in the assembly frame.

5. The gripping device according to claim 1, wherein an inner surface of each of the claw plates is an arc surface that is matched with an outer peripheral surface of the gripping head.

6. The gripping device according to claim 1, wherein the drive assembly comprises a motor, a gearbox and a plurality of reduction gears, wherein the plurality of reduction gears are meshed in sequence; a base of the motor is fixed on the gearbox; an output shaft of the motor is connected to a central bore of one of the reduction gears; the central bore of another reduction gear is connected to an upper end of the piston rod; power of the motor is transmitted sequentially through the reduction gears for speed reduction and transmitted to the piston rod to drive a rotation of the piston rod; and an upper end of the piston body is fixedly connected to the gearbox.

7. The gripping device according to claim 1, wherein the centering assembly is internally provided with three cameras, three claw plates and three claw arms.

8. The gripping device according to claim 1, wherein the cross-slider coupling comprises a first body, a cross sliding block, and a second body which are connected in sequence; an upper end of the first body is fixedly connected to a lower end of the transmission rod; a first guide groove recessed toward an inside of the first body is provided at an end of the first body facing the cross sliding block; and a second guide groove recessed toward an inside of the second body is provided at an end of the second body facing the cross sliding block; an axial direction of the second guide groove is perpendicular to an axial direction of the first guide groove; an end of the second body facing away from the cross sliding block is fixedly connected to the gripping head; the cross sliding block is provided with a first guide surface matched with the first guide groove and a second guide surface matched with the second guide groove; and both the first guide surface and the second guide surface are a combination of an arc surface and a vertical plane.

9. The gripping device according to claim 8, wherein two first arc surfaces are further provided at an end of the first body facing the cross sliding block, and the two first arc surfaces are symmetrically disposed on both sides of the first guide groove and located at an edge of the first body; and two second arc surfaces are further provided at an end of the second body facing the cross sliding block, and the two second arc surfaces are symmetrically disposed on both sides of the second guide groove and located at an edge of the second body.

10. The gripping device according to claim 8, wherein a connector is provided at a center of the upper end of the first body, and the connector is inserted and fixed into a connection hole in the lower end of the transmission rod; a clamping groove for mounting retaining rings is disposed on an outer peripheral surface of the first body; and the retaining rings are configured to limit a position of a crosshead assembly sleeve along an axial direction of the piston, wherein the crosshead assembly sleeve is sleeved between the piston body and the outer peripheral surface of the first body.
